(19) United States
(12) Patent Application Publication
(10) Pub. No.: US 2013/0090008 A1
(43) Pub. Date: Apr. 11, 2013

(54) COAXIAL CABLE CONNECTOR STRUCTURE

(71) Applicant: Shou-Ying WANG, Taipei City (TW)

(72) Inventor: Shou-Ying WANG, Taipei City (TW)

(21) Appl. No.: 13/344,912

(22) Filed: Jan. 6, 2012

(30) Foreign Application Priority Data
Oct. 7, 2011 (TW) 100218900

(51) Int. Cl. H01R 9/05

(52) U.S. Cl. 439/578

(57) ABSTRACT

A coaxial cable connector structure including a sleeve and an annular nut on the front end of the sleeve is disclosed, wherein an inner tube is disposed inside the sleeve for connecting the coaxial cable, and a spring is disposed on the bottom of the annular nut for the end surface of the connection base towards the annular nut to contact the spring and electrically connect the inner tube when the connection base is screwed into the annular nut, so that the coaxial cable connector structure can transmit signals when it is not completely screwed onto the connection base, and provide the effect of vibration suppression from the compressed spring having its two ends abutted against the bottom of the annular nut and the end surface of the connection base by the elastic restoring force when the connection base is completely screwed onto the connection base.

### BACKGROUND OF THE INVENTION

1. Field of the Invention

The present invention relates to a coaxial cable connector structure, and more particularly to a coaxial cable connector structure having a spring disposed inside the annular nut for electrically connecting the coaxial cable connector and the connection base when the coaxial cable connector is loosened or not completely screwed onto the connection base.

2. Description of Related Art

The coaxial cable is a signal transmission cable widely used in television and network systems, which is fixed on the corresponding connection base of a video or network equipment by the coaxial cable connector set at the end. For example, a common F-type coaxial cable connector connects to the coaxial cable through a sleeve, a rotatable annular nut is disposed on the front end of the sleeve, and an inner thread is disposed on the inner surface of the annular nut and a hexagonal outer wall is disposed on its outer surface for rotating to fasten by fingers or clamping tools.

The annular nut needs to be rotated repeatedly for completely rotating inside the connection base when fastening the abovementioned coaxial cable connector on the connection base by manual rotating, to thereby ensure electrical connection for transmitting signals from the coaxial cable. However, since the outer contact area of the annular nut is small, it cannot be effectively forced to rotate by fingers, the motion of fastening the annular nut by fingers is time-consuming and labor-intensive. Also, since the connection base is disposed on the back side of the abovementioned equipments mostly, users should move out the equipments for completely fastening the coaxial cable connector behind when the equipments are set in a narrow space, thus it may cause considerable inconvenience.

In view of this, in order to improve the abovementioned defects for transmitting signals when the coaxial cable connector structure is not completely fastened on the connection base, to thereby increase convenience in use. Due to the experiences in many years and continuous developments and improvements, the inventor completes the present invention.

### SUMMARY OF THE INVENTION

The object of the present invention is to provide a coaxial cable connector structure, wherein a spring is disposed on the bottom of the annular nut for the end surface of the connection base towards the annular nut to contact the spring and electrically connect the inner tube of the sleeve when the connection base is not completely screwed into the inner thread of the annular nut.

In order to achieve the abovementioned object, the coaxial cable connector structure according to the present invention includes a sleeve and an annular nut disposed on the front end of the sleeve, and an inner tube is disposed inside the sleeve for connecting the coaxial cable, and the annular nut has an inner thread on its inner surface for combining with a connection base having an outer thread, wherein a spring is disposed on the bottom of the annular nut for the end surface of the connection base towards the annular nut to contact the spring and electrically connect the inner tube when the connection base is screwed into the inner thread of the annular nut.

When implemented, a flange part is disposed on the front end of the inner tube for engaging the bottom of the annular nut, and a gap is formed between the flange part and the annular nut for receiving the spring inside.

When implemented, the flange part has an indentation thereon for receiving an O-ring within it.

When implemented, one end of the spring is fixed on the bottom of the annular nut.

When implemented, the spring is engaged on the inner thread of the annular nut.

When implemented, the outer diameter of the spring is smaller than or equal to the inner diameter of the annular nut.

When implemented, the spring is a metal spring with the electric conductivity.

When implemented, the thickness of the flange part is greater than or equal to the height of the spring after being compressed.

When implemented, a flange part is disposed on the front end of the inner tube for engaging the bottom of the annular nut, and a groove is disposed on the flange part for placing and receiving the spring inside.

When implemented, the depth of the groove is greater than or equal to the height of the spring after being compressed.

In order to further understand the present invention, the prefer embodiments are described with figures and numbers as follow to illustrate the practical construction and the achieved effects of the present invention.

### BRIEF DESCRIPTION OF THE DRAWINGS

FIG. 1 is a schematic combination diagram of a coaxial cable connector structure according to the first embodiment of the present invention;

FIG. 2 is a three-dimension diagram of the embodiment in FIG. 1;

FIG. 3 is a schematic combination diagram of the embodiment in FIG. 1 when being combined with the coaxial cable;

FIG. 4 is a three-dimension diagram of the embodiment in FIG. 1 after being combined with the coaxial cable;

FIG. 5 is a schematic section diagram of the embodiment in FIG. 1;

FIG. 6A is a schematic section diagram of the embodiment in FIG. 1 when being combined with the coaxial cable;

FIG. 6B is a schematic section diagram of the embodiment in FIG. 1 after being combined with the coaxial cable;

FIG. 7 is a three-dimension diagram of a coaxial cable connector structure according to the second embodiment of the present invention;

FIG. 8 is a schematic section diagram of the embodiment in FIG. 7 after being combined with the coaxial cable;

FIG. 9 is a three-dimension diagram of a coaxial cable connector structure according to the third embodiment of the present invention;

FIG. 10A is a schematic section diagram of the embodiment in FIG. 9 when the connection base is screwed into the annular nut;

FIG. 10B is a schematic section diagram of the embodiment in FIG. 9 when the connection base is totally screwed into the annular nut.

### DETAILED DESCRIPTION OF THE INVENTION

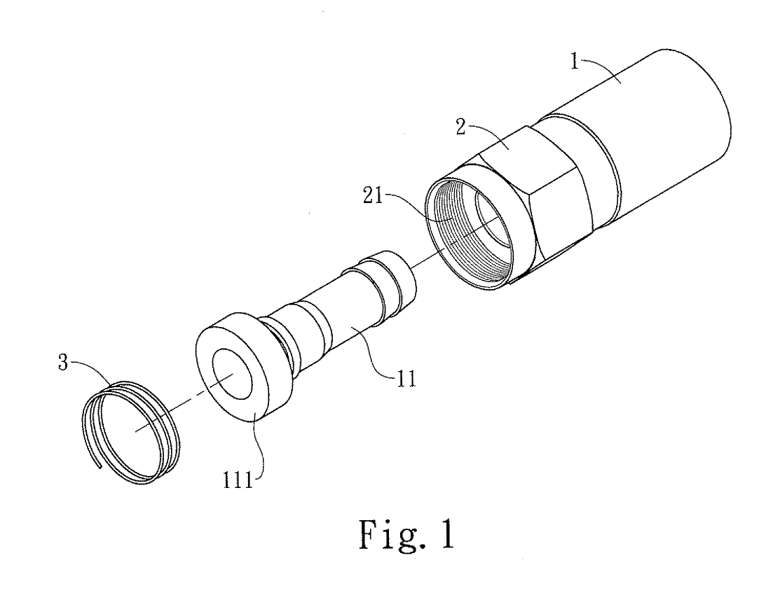

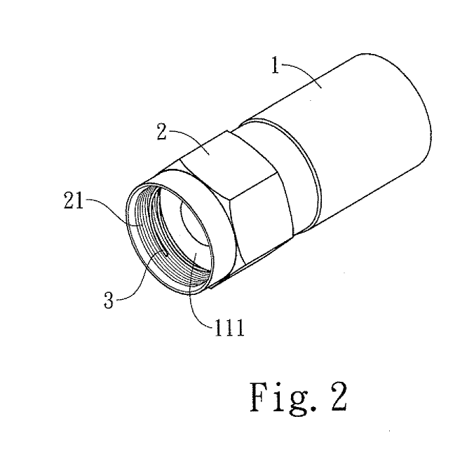

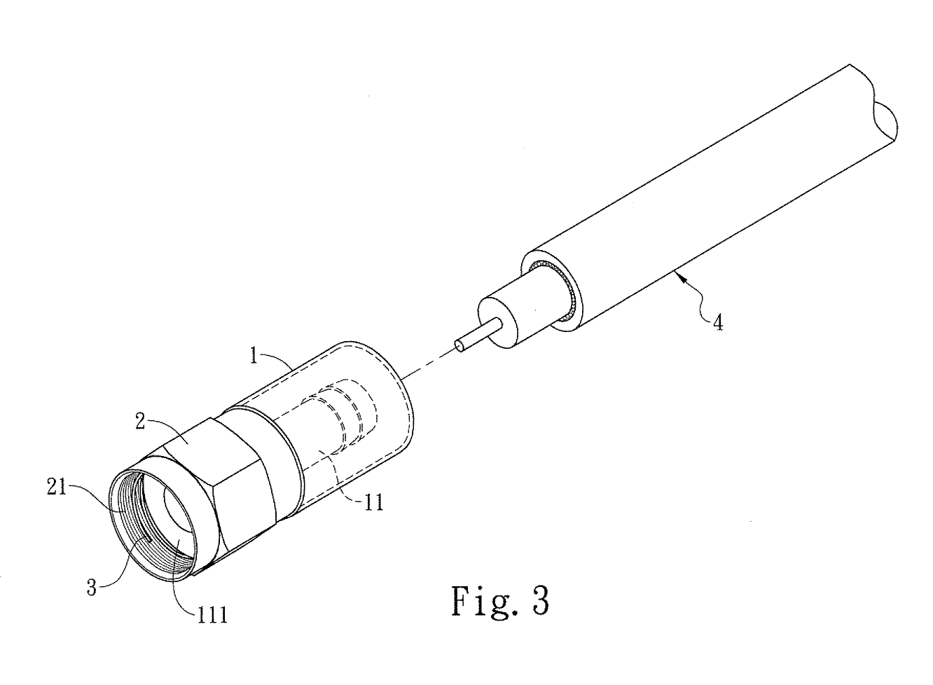

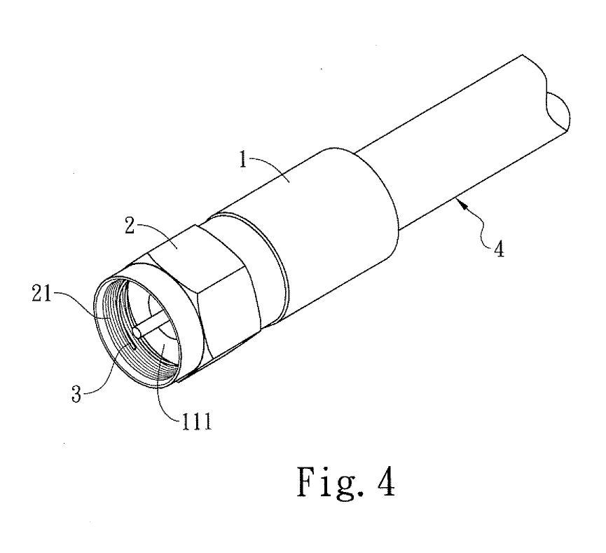

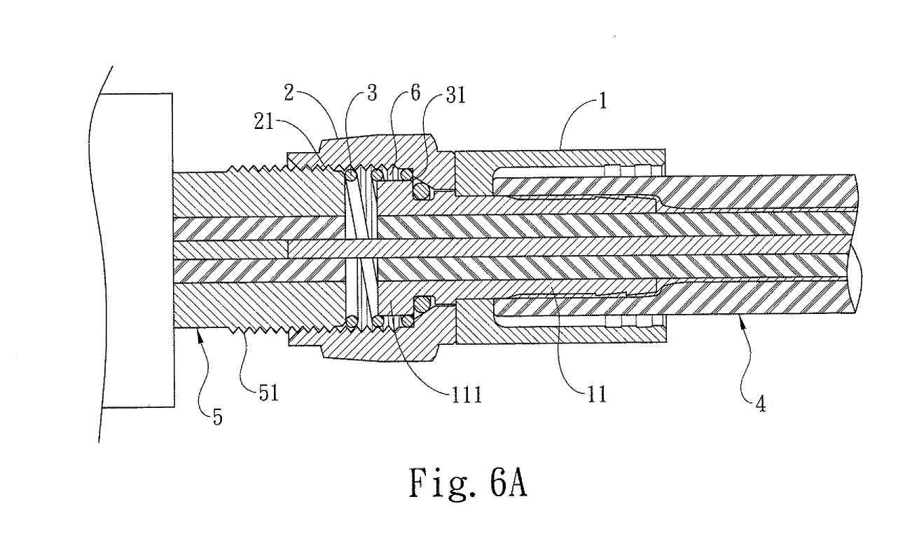

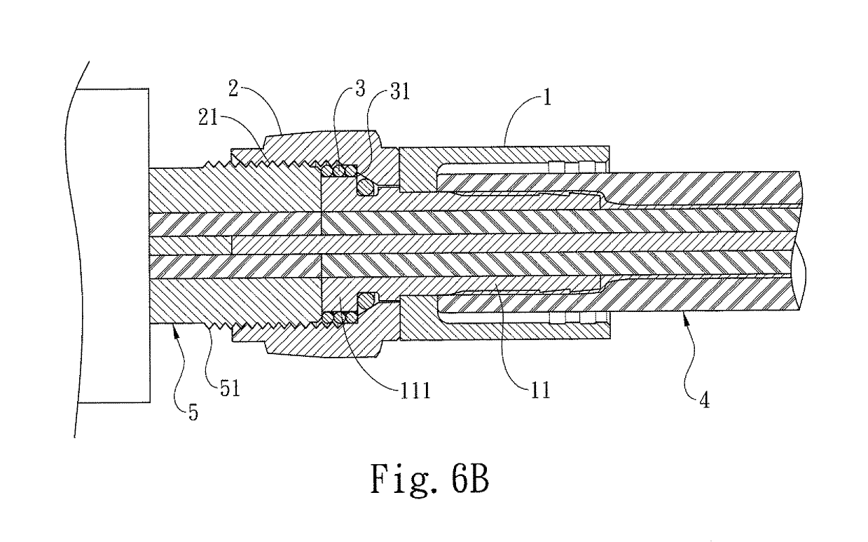

Please refer to FIG. 1 and FIG. 2, which are the first embodiment of the coaxial cable connector structure of the present invention, and includes a sleeve 1, an annular nut 2 disposed on the front end of the sleeve 1, and a spring 3, wherein an inner tube 11 is disposed inside the sleeve 1 for connecting the coaxial cable 4 (as shown in FIG. 3 and FIG. 4), and a flange part 111 disposed on the front end of the inner tube 11 is combined with the bottom inside the annular nut 2 for spacing the annular nut 2 on the front end of the sleeve 1, and a gap 20 is formed between the flange part 111 and the annular nut 2. The annular nut 2 has an inner thread 21 on its inner surface for connecting a connection base 5 having an outer thread 51 (as shown in FIG. 6A).

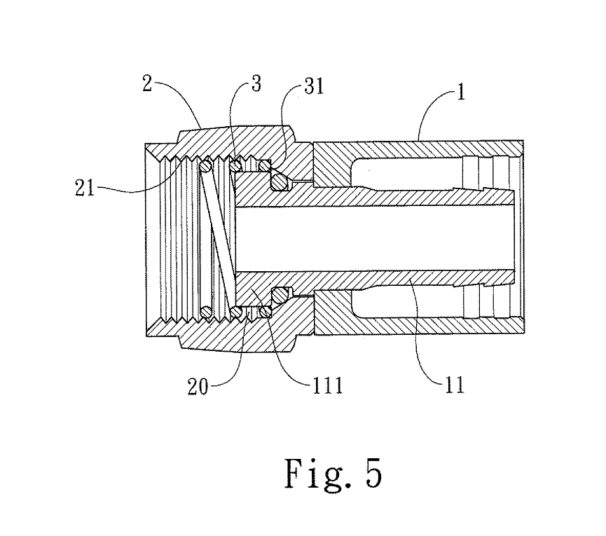

The spring 3 is made of electric conductive metal material, and disposed inside the gap 20 between the flange part 111 and the annular nut 2 in the annular nut 2 (as shown in FIG. 5). The bottom end 31 of the spring 3 is fixed on the bottom of the annular nut 2, and the outer diameter of the spring 3 is slightly smaller than the inner diameter of the annular nut 2 for engaging the inner thread 21 of the annular nut 2. The outer diameter of the spring 2 may be designed as equal to the inner diameter of the annular nut 2.

When implemented, please refer to FIG. 6A and FIG. 6B, according to the present invention, when the connection base 5 is screwed into the annular nut 2, it allows the end surface of the connection base 5 towards the annular nut 2 to contact the spring Sand electrically connect to the inner tube 11 of the annular nut 2 via the spring 3. Besides, the thickness of the flange part 111 is greater than or equal to the height of the spring 3 after being compressed for completely placing and receiving the compressed spring 3 in the gap 20 when the connection base 5 is completely screwed into the annular nut 2 and the end surface of the connection base 5 towards the annular nut 2 contacts the upper surface of the inner tube 11 to electrically connect for transmitting signals.

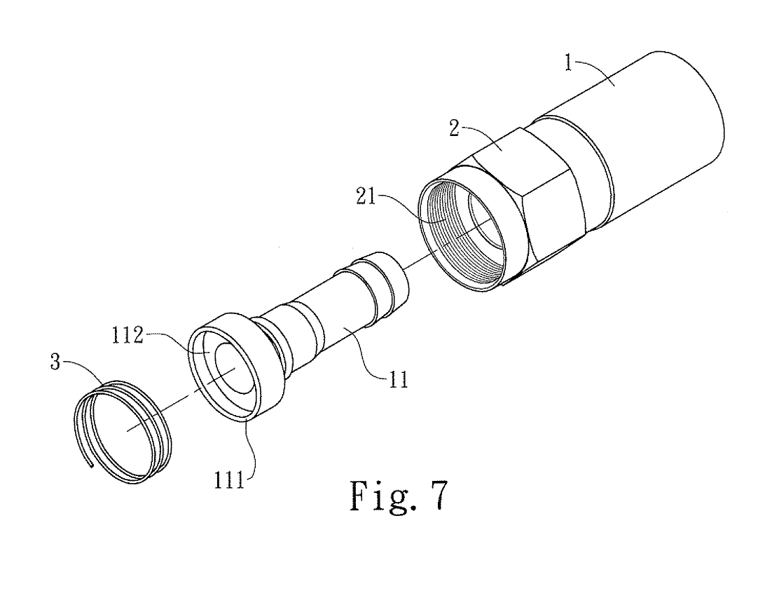

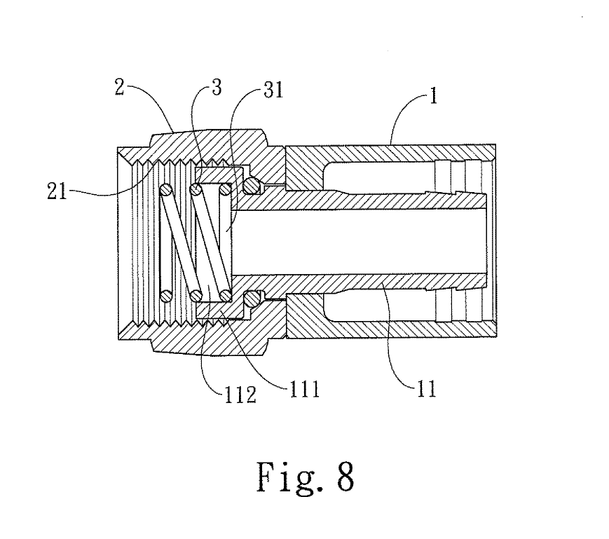

Please refer to FIG. 7 and FIG. 8, which is the second embodiment of the coaxial cable connector structure according to the present invention, and using the structure of the abovementioned first embodiment as its base. A flange part 111 is disposed on the front end of the inner tube 11 on the bottom of the annular nut 2 for engaging the bottom of the annular nut 2. A groove 112 is disposed on the flange part 111, and the depth of the groove 112 is greater than or equal to the height of the spring 3 after being compressed for completely placing and receiving the spring 3 after being compressed inside.

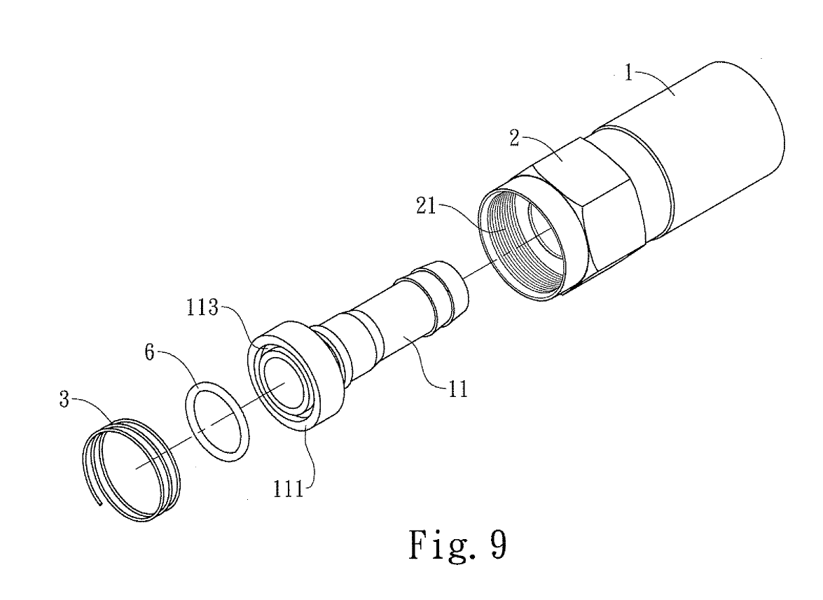

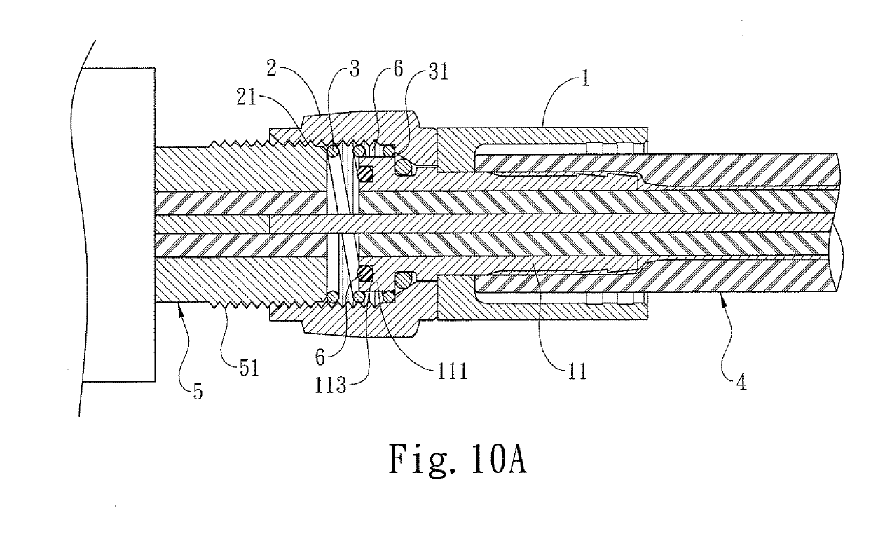

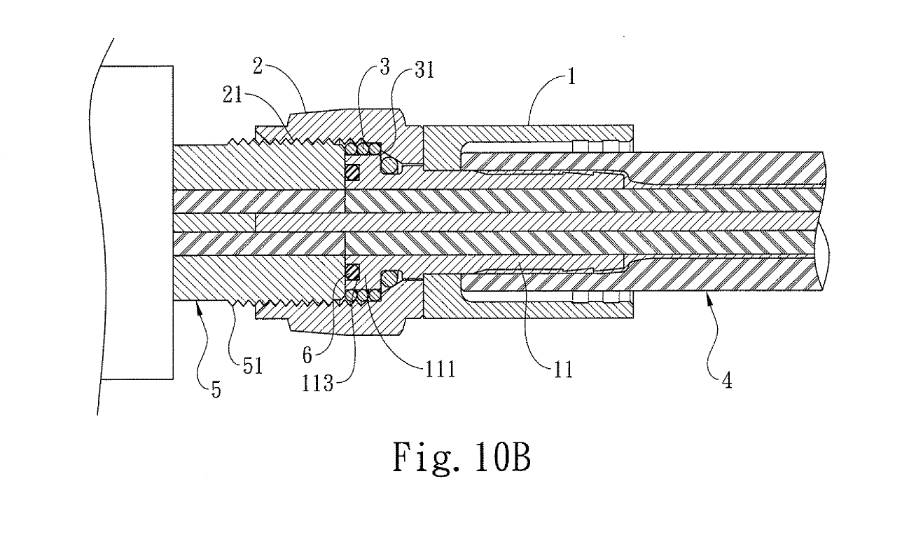

Please refer to FIG. 9, which is the third embodiment of the coaxial cable connector structure according to the present invention, and using the structure of the abovementioned first embodiment as its base. An indentation 113 is disposed on the flange part 111 for receiving an O-ring 6 within the indentation 113. The cross-sectional diameter of the O-ring 6 is lightly larger than the depth of the indentation 113 (as shown in FIG. 10), so that when the connection base 5 is totally screwed into the annular nut 2 and pressing the O-ring 6 with the end surface of the connection base 5 towards the annular nut 2, a sealing barrier is formed between the end surface of the connection base 5 and the flange part 111 to prevent water from flowing into the central copper conductor of the coaxial cable 4.

Therefore, the present invention has the following advantages:

1. In a general installation process, the spring may be used for conducting signals of the coaxial cable when the coaxial cable connector is hard to completely screw onto the connection base, so users may conveniently operate in a narrow space, and the present invention may keep transmitting signal when the coaxial cable connector is loosened.

2. When the coaxial cable connector and the connection base are in the condition of completely screwed, because of elastic restoring force, two ends of the compressed spring are respectively abutted against the bottom of the coaxial cable connector and the end surface of the connection base towards the annular nut, and the spring can provide the effect of vibration suppression when the coaxial cable connector and the connection base suffer external vibration.

3. When water accidentally flows into the connection base, the present invention can maintain the transmitting of electrical signals of the coaxial cable by the O-ring disposed on the flange part of the connection base, thereby increasing the practicality significantly.

4. The structure of the present invention is simple and may be directly applied in the current specification of the coaxial cable connector, to increase the practicality significantly.

In summary, according to the contents disclosed above, the present invention may indeed achieve the intended purpose to provide a coaxial cable connector structure, which may transmit signals when the coaxial cable connector cannot be fastened into the connection completely or the coaxial cable connector is loosened. Thus, the present invention has industrial application and the inventor files an application for a patent according to law.

It should be understood that different modifications and variations could be made from the disclosures of the present invention by the people familiar in the art without departing the spirit of the present invention.

What is claimed is:

1. A coaxial cable connector structure including a sleeve and an annular nut disposed on the front end of the sleeve, and an inner tube disposed inside the sleeve for connecting the coaxial cable, the annular nut having an inner thread on its inner surface for combining with a connection base having an outer thread, characterized in that a spring is disposed on the bottom of the annular nut for the end surface of the connection base towards the annular nut to contact the spring and electrically connect the inner tube when the connection base is screwed into the inner thread of the annular nut.

2. The coaxial cable connector structure as claimed in claim 1, wherein a flange part is disposed on the front end of the inner tube for engaging the bottom of the annular nut, and a gap is formed between the flange part and the annular nut for receiving the spring inside.

3. The coaxial cable connector structure as claimed in claim 2, wherein the flange part has an indentation thereon for receiving an O-ring within it.

4. The coaxial cable connector structure as claimed in claim 2, wherein one end of the spring is fixed on the bottom of the annular nut.

5. The coaxial cable connector structure as claimed in claim 2, wherein the spring is engaged on the inner thread of the annular nut.

6. The coaxial cable connector structure as claimed in claim 2, wherein the outer diameter of the spring is smaller than or equal to the inner diameter of the annular nut.

7. The coaxial cable connector structure as claimed in claim 2, wherein the spring is a metal spring with electric conductivity.

8. The coaxial cable connector structure as claimed in claim 2, wherein the thickness of the flange part is greater than or equal to the height of the spring after being compressed.

9. The coaxial cable connector structure as claimed in claim 1, wherein a flange part is disposed on the front end of the inner tube for fixing the bottom of the annular nut, and a groove is disposed on the flange part for receiving the spring.

10. The coaxial cable connector structure as claimed in claim 9, wherein the spring is a metal spring with electric conductivity.

11. The coaxial cable connector structure as claimed in claim 9, wherein the depth of the groove is greater than or equal to the height of the spring after being compressed.
